(19) United States
(12) Patent Application Publication
(10) Pub. No.: US 2016/0223076 A1
(43) Pub. Date: Aug. 4, 2016

(54) SHIFT CONTROL APPARATUS OF MANUAL TRANSMISSION

(71) Applicant: KYUNG CHANG INDUSTRIAL CO., Ltd., Daegu (KR)

(72) Inventors: Jin Bo KIM, Daegu (KR); Dong Won KIM, Daegu (KR)

(21) Appl. No.: 14/979,550

(22) Filed: Dec. 28, 2015

(30) Foreign Application Priority Data
Feb. 4, 2015 (KR) 10-2015-0017325

(51) Int. Cl. F16H 61/16; F16H 59/04

(52) U.S. Cl. CPC F16H 61/16; F16H 59/04; F16H 59/044

(57) ABSTRACT

A shift control apparatus of a manual transmission is disclosed. The shift control apparatus includes: a shift lever including a rod; a shift lock limiting the movement of the rod; and a controller which compares a speed of a vehicle with a predetermined critical speed of a predetermined gear and controls the shift lock. When the speed of the vehicle is greater than the critical speed, the controller controls the shift lock to be located on a shift path of the predetermined gear, and then limits the movement of the rod in a shift direction of the predetermined gear.

### CROSS-REFERENCE TO RELATED APPLICATION

The present application claims priority under 35 U.S.C. §119(a) of Korean Patent Application No. 10-2015-0017325 filed Feb. 4, 2015, the subject matters of which are incorporated herein by reference.

### BACKGROUND

1. Field

The present disclosure relates to a shift control apparatus of a manual transmission, and more particularly to a shift control apparatus of a manual transmission, which is capable of limiting shifting to a low gear at a high speed.

2. Description of the Related Art

A transmission is installed between a clutch and a propeller shaft and transfers a power of an engine to a drive wheel by increasing or decreasing a rotational force of the engine in accordance with a driving state of a vehicle.

The engine of the vehicle has a constant rotation direction. A torque generated in the engine is almost constant within a practical rotation speed range, whereas a driving condition of the vehicle varies widely, for example, start from a stop state, a high speed driving from a low speed driving, particularly, a reverse driving, etc. Therefore, the transmission is used to allow the engine to sufficiently show its performance in response with each of the driving conditions.

The transmission has various types including a manual transmission, an automatic transmission, a semi-automatic transmission, a continuously variable transmission, etc.

By the operation of a driver, the manual transmission among the above-described various transmissions changes a shift ratio, reverses a rotation direction, and creates a state where no power is transferred. The manual transmission consumes less fuel and has a less power loss as compared with the automatic transmission.

The driver shifts a gear himself/herself. Hence, the driver may shift to a low gear, for example, the first gear or the second gear intentionally or by mistake even though the vehicle is driven at a high speed. In this case, an overload is added to the manual transmission, and thus, the manual transmission may be damaged.

### SUMMARY

One embodiment is a shift control apparatus of a manual transmission. The shift control apparatus includes: a shift lever including a rod; a shift lock limiting the movement of the rod; and a controller which compares a speed of a vehicle with a predetermined critical speed of a predetermined gear and controls the shift lock. When the speed of the vehicle is greater than the critical speed, the controller controls the shift lock to be located on a shift path of the predetermined gear, and then limits the movement of the rod in a shift direction of the predetermined gear.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

The shift lock includes: a solenoid including a shaft which linearly reciprocates in a left select direction of the rod and in a right select direction of the rod; and a shift lock cam which includes one end and the other end connected to the shaft, wherein a rotational axis is disposed between the one end and the other end. When the shaft moves in the left select direction by the controller, the one end is located on the shift path of the predetermined gear.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

The shift lock further includes a shaft which linearly reciprocates in a left select direction of the rod and in a right select direction of the rod, and a sensor which senses a position of the shaft. The sensor transmits information on the sensed position of the shaft to the controller. The controller determines whether the shift lock is in an open-state or in a locked-state on the basis of the received information on the position of the shaft.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

The shaft includes a magnet. The sensor includes a hall IC which senses a distance between magnet and the hall IC.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

The shift lever further includes a stopper mounted on the rod. The stopper is mounted to lean in a left select direction of the rod.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

The rod further includes a stopper. The stopper has a shape protruding in a left select direction of the rod.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

The shift control apparatus further includes an electronic control unit which measures the speed of the vehicle. The controller receives the speed of the vehicle from the electronic control unit.

The shift lock includes a first shift lock and a second shift lock which are operated independently of each other. The predetermined gear includes a first gear and a second gear. The critical speed includes a first critical speed of the first gear and a second critical speed of the second gear. The second critical speed is greater than the first critical speed. When the speed of the vehicle is less than the second critical speed and is greater than the first critical speed, the controller controls the first shift lock to be located on a shift path of the first gear and controls the second shift lock not to be located on a shift path of the second gear.

### BRIEF DESCRIPTION OF THE DRAWINGS

Arrangements and embodiments may be described in detail with reference to the following drawings in which like reference numerals refer to like elements and wherein:

FIG. 1 is a perspective view of a shift control apparatus of a manual transmission according to an embodiment of the present invention;

FIG. 2 is a perspective view showing the shift control apparatus of the manual transmission shown in FIG. 1, of which some parts have been removed;

FIG. 3 is a perspective view of the shift control apparatus of the manual transmission shown in FIG. 2, as viewed in another direction;

FIG. 4 is an enlarged view of a shift pattern 135 shown in FIG. 2;

FIG. 5 is a side view showing a modified example of a rod 110 shown in FIG. 2;

FIG. 6 is a perspective view of a shift lock 200 shown in FIG. 2;

FIG. 7 shows that shift lock cams 230a and 230b shown in FIG. 6 have performed a rotational motion at a predetermined angle in a clockwise direction with interworking with a straight line motion of shafts 213a and 213b;

FIGS. 8 to 9 are views showing an example where a first shift lock 200a shown in FIG. 2 limits the movement of the rod 110 in a shift direction of a first gear; and

FIG. 10 is a view showing a state where the first shift lock 200a and a second shift lock 200b limit the movement of the rod 110.

### DETAILED DESCRIPTION

An embodiment of the present invention will be described in detail with reference to the accompanying drawings. In the components of the present invention, detailed descriptions of what can be clearly understood and easily carried into practice through a prior art by those skilled in the art will be omitted to avoid making the subject matter of the present invention unclear.

### Embodiment

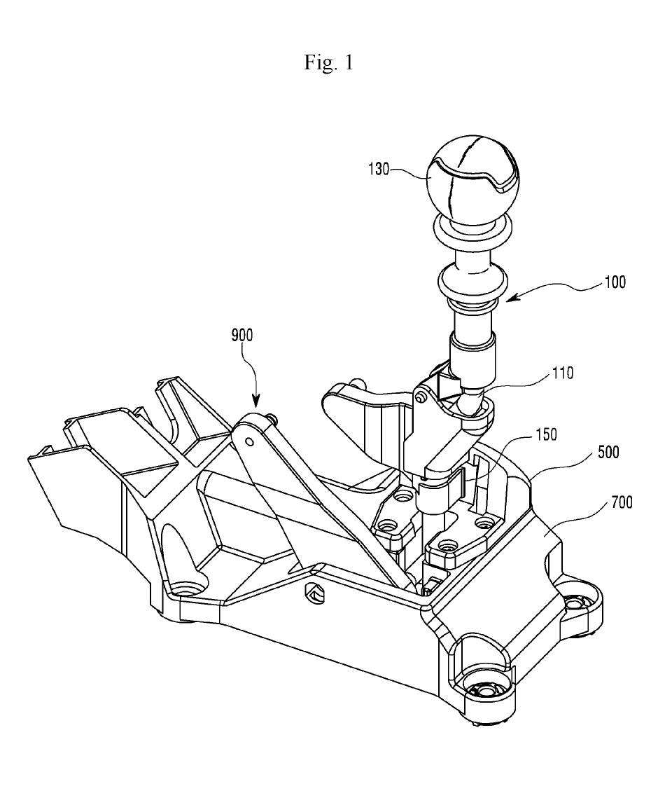

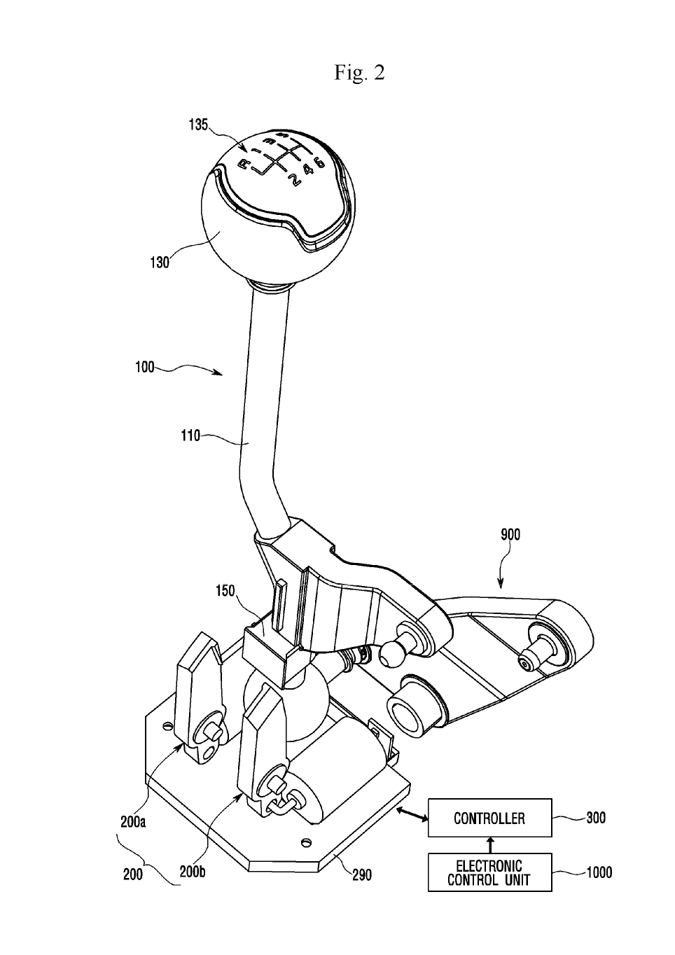

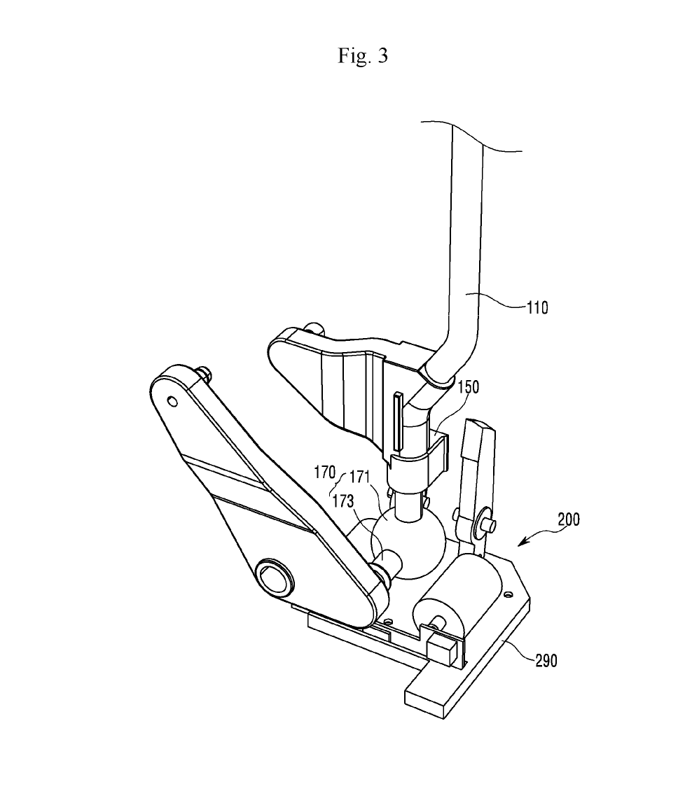

FIG. 1 is a perspective view of a shift control apparatus of a manual transmission according to an embodiment of the present invention. FIG. 2 is a perspective view showing the shift control apparatus of the manual transmission shown in FIG. 1, of which some parts have been removed. FIG. 3 is a perspective view of the shift control apparatus of the manual transmission shown in FIG. 2, as viewed in another direction.

Prior to the description of the shift control apparatus of the manual transmission according to the embodiment of the present invention with reference to FIGS. 1 to 3, terms required to describe the shift control apparatus of the manual transmission according to the embodiment of the present invention will be defined.

In the present specification, a “predetermined gear” means any one of the first to n-th gears of the manual transmission (here, n is a natural number greater than 1). Here, n may be determined according to the kind of the manual transmission.

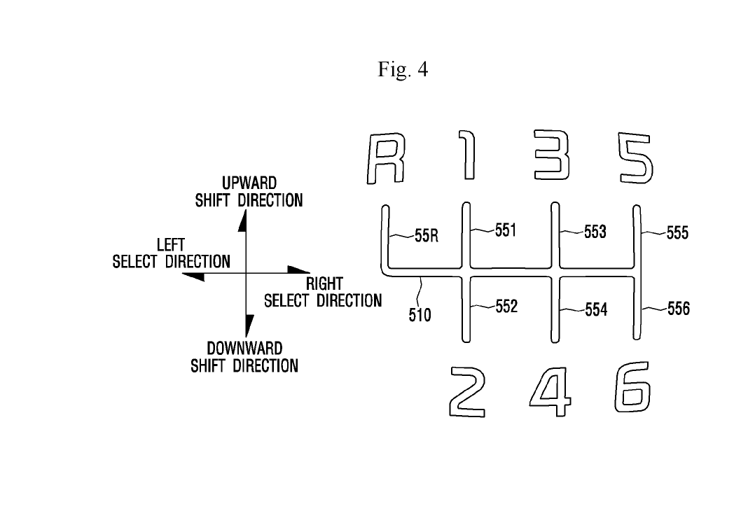

The shift control apparatus of the manual transmission according to the embodiment of the present invention may include a first to sixth forward gears and one reverse gear (R). The predetermined gear will be described in more detail with reference to FIG. 4.

FIG. 4 is an enlarged view of a shift pattern 135 shown in FIG. 2.

The shift pattern 135 shown in FIG. 4 may be engraved or embossed in a rod 110 of a shift lever 100 shown in FIG. 2. The rod 110 shown in FIG. 2 is moved along the shift pattern by a driver.

The shift pattern may include one select pattern 510 and a plurality of shift patterns 551, 552, 553, 554, 555, 556, and 55R.

The reverse gear (R), the first gear, the third gear, and the fifth gear are disposed above the select pattern 510. The second gear, the fourth gear, and the sixth gear are disposed below the select pattern 510. The first, third, and fifth gears are disposed symmetrically with the second, fourth, and sixth gears, respectively with respect to the select pattern 510. A neutral gear position may be disposed on the select pattern 510 between the third gear and the fourth gear.

In order to shift the rod 110 located at the neutral gear position to the first gear, the rod 110 is moved along the select pattern 510 in a left select direction, and then should be moved along the shift pattern 551 corresponding to the first gear in an upward shift direction.

In order to shift to a low speed gear (the first gear or the second gear) while a vehicle is driven at a high speed, for example, the rod 110 is located at a high speed position (any one of the fourth to sixth gears), it is required that the rod 110 should be moved to the neutral gear position and moved along the select pattern 510 in the left select direction, and then should be moved along the shift pattern 551 and 552 in the upward shift direction or in a downward shift direction.

As such, the rod 110 should be moved along a “predetermined path” so as to shift to a predetermined gear. The “predetermined path” includes at least one “select path” and at least one “shift path”. In the present specification, the “select path” means a trace of the rod 110 moving along the select pattern 510, and the “shift path” means a trace of the rod 110 moving along any one of the plurality of shift patterns 551, 552, 553, 554, 555, 556, and 55R.

Meanwhile, in the present specification, a “critical speed” means a speed corresponding to each of the “predetermined gears”. The critical speed may be variously set by automobile manufacturers or designers. For example, the critical speed of the first gear may be set to 15 km/h, and the critical speed of the second gear may be set to 30 km/h.

Referring back to FIGS. 1 to 3, the shift control apparatus of the manual transmission according to the embodiment of the present invention includes the shift lever 100 including the rod 110, a shift lock 200 limiting the movement of the rod 110, and a controller 300 controlling the shift lock 200. Here, the controller 300 compares the speed of the vehicle with a predetermined critical speed of the predetermined gear. As a result of the comparison, if the speed of the vehicle is greater than the critical speed, the controller 300 controls the shift lock 200 to be located on the shift path of the predetermined gear, thereby limiting the movement of the rod 110 in the shift direction of the predetermined gear.

According to the shift control apparatus of the manual transmission according to the embodiment of the present invention, when the speed of the vehicle is greater than the critical speed of the predetermined gear at a point of time of the shift-down, it is possible to prevent the shift-down and to reduce the overload of the manual transmission.

The structure of the shift control apparatus of the manual transmission according to the embodiment of the present invention will be described in detail with reference to FIGS. 1 to 3.

The shift control apparatus of the manual transmission according to the embodiment of the present invention may further include a cover 500, a bracket 700, a select lever 900, and an electronic control unit (ECU) 1000 as well as the shift lever 100, the shift lock 200, and the controller 300. The respective components will be described in detail below.

The shift lever 100 may include the rod 110, a knob 130, a stopper 150, and an insert outer 170.

The rod 110 is used to shift the gear. The rod 110 can be moved along the shift pattern shown in FIG. 4 by the driver.

The knob 130 is provided on the top of the rod 110. The shift pattern 135 shown in FIG. 4 may be formed in the knob 130.

The stopper 150 is mounted on the rod 110. The stopper 150 may be mounted between the top and bottom of the rod 110. The stopper 150 may be mounted between the knob 130 and the insert outer 170. The stopper 150 may be mounted to lean in a particular direction on the edge or circumference of the rod 110. Here, the particular direction corresponds to the select direction shown in FIG. 4, and in more detail, may be the left select direction, i.e., the select directions of the first gear and second gear.

When the stopper 150 is caught by the contact with the shift lock 200, the movement of the rod 110 in the shift direction of the predetermined gear is limited.

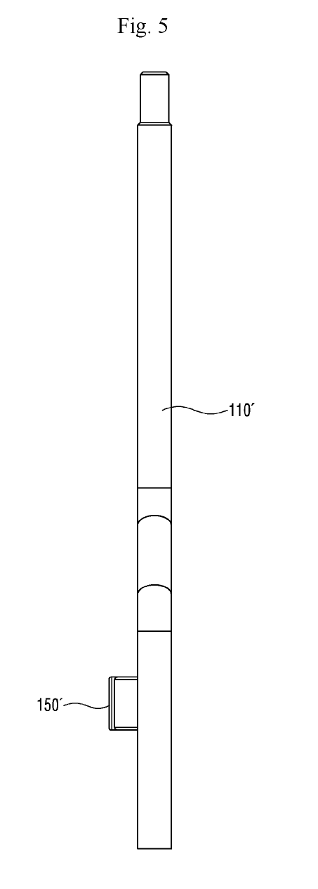

Here, the stopper 150 is not necessary. That is, as long as a portion of the rod 110 can function as the stopper 150, the stopper 150 may not be required. In this case, the rod 110 is caught by the shift lock 200, and thus, the movement of the rod 110 in the shift direction of the predetermined gear may be limited. Specifically, the stopper 150 may be a portion of the rod 110 without being mounted on the rod 110. Specifically, this will be described with reference to FIG. 5.

FIG. 5 is a side view showing a modified example of the rod 110 shown in FIG. 2.

Referring to FIG. 5, a rod 110′ may include a stopper 150′. The stopper 150′ may have a shape protruding from a portion of the rod 110′ in the left select direction shown in FIG. 4. Since the rod 110′ includes the stopper 150′, the stopper 150′ does not necessarily need to be formed as a separate member like the stopper 150 shown in FIGS. 2 to 3. Therefore, the shift control apparatus of the manual transmission according to the embodiment of the present invention has a simpler internal structure and a reduced manufacturing cost.

Referring back to FIGS. 1 to 3, the insert outer 170 is mounted below the rod 110. The insert outer 170 includes a first portion 171 and a second portion 173. The first portion 171 has a spherical shape which can rotate by the operation of the rod 110. The second portion 173 is formed extending from the first portion 171 toward the select lever 900. The second portion 173 is coupled to the select lever 900.

The shift lock 200 may limit or block of the movement of the rod 110 in the shift direction of the predetermined gear by the control of the controller 300.

The shift lock 200 may be disposed adjacent to the shift lever 100. Specifically, the shift lock 200 may be disposed below the shift lever 100. As such, since the shift lock 200 is disposed adjacent to the shift lever 100, spatial degrees of freedom are improved.

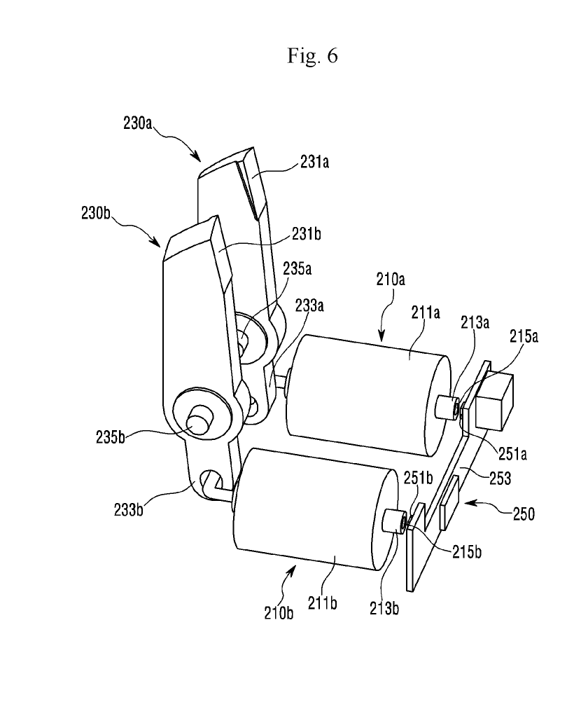

One shift lock 200 or a plurality of shift locks 200 may be provided. When the plurality of shift locks 200 are provided, the shift lock 200 may include a first shift lock 200a and a second shift lock 200b. The structure of the shift lock 200 will be described in detail with reference to FIG. 6.

FIG. 6 is a perspective view of the shift lock 200 shown in FIG. 2.

While the two first and second shift locks 200a and 200b of the shift lock 200 are shown together in FIG. 6, one shift lock 200 may be provided.

The first and second shift locks 200a and 200b have the same structure.

Referring to FIG. 6, the first and second shift locks 200a and 200b may include solenoids 210a and 210b and shift lock cams 230a and 230b, respectively.

The solenoids 210a and 210b may include bodies 211a and 211b and shafts 213a and 213b.

The shafts 213a and 213b are mounted on the bodies 211a and 211b. Specifically, the shafts 213a and 213b may be mounted on the central axes of the cylindrical bodies 211a and 211b.

Magnets 215a and 215b are disposed within the shafts 213a and 213b. Permanent magnets (not shown) may be disposed within the bodies 211a and 211b.

The shafts 213a and 213b may linearly reciprocate by the controller 300. The linear reciprocation of the shafts 213a and 213b can be made by an attractive force and a repulsive force between the magnets 215a and 215b mounted within the shafts 213a and 213b and the permanent magnets mounted within the bodies 211a and 211b. The controller 300 controls the direction of a current applied to the bodies 211a and 211b, and then changes the polarity of a magnetic field within the bodies 211a and 211b, so that the shafts 213a and 213b can linearly reciprocate.

The shift lock cams 230a and 230b include one ends 231a and 231b and the other ends 233a and 233b. The one ends 231a and 231b block the movement of the rod 110. The other ends 233a and 233b are connected to the shafts 213a and 213b. Rotational axes 235a and 235b are disposed between the one ends 231a and 231b and the other ends 233a and 233b.

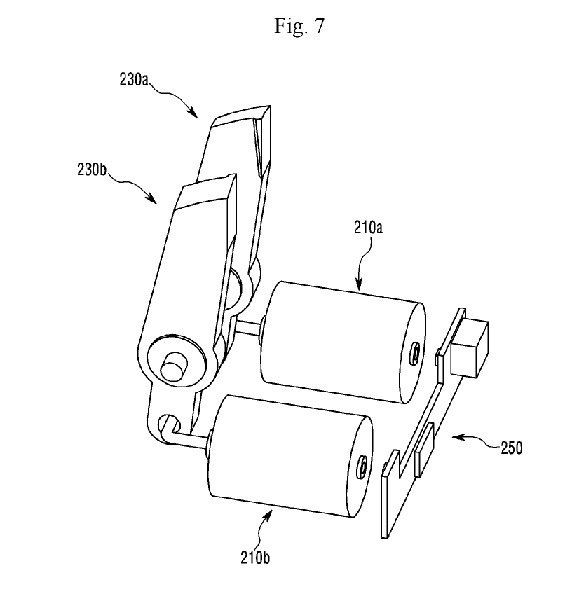

The shift lock cams 230a and 230b are able to perform reciprocating rotation with interworking with the linear reciprocation of the shafts 213a and 213b. FIG. 7 shows that the shift lock cams 230a and 230b shown in FIG. 6 have performed a rotational motion at a predetermined angle in a clockwise direction with interworking with the straight line motion of shafts 213a and 213b.

The shift lock 200 may further include a sensor 250. The sensor 250 senses the positions of the shafts 213a and 213b. The sensor 250 transmits information on the sensed positions of the shafts 213a and 213b to the controller 300. On the basis of the received information on the positions of the shafts 213a and 213b, the controller 300 is able to determine the states of the shift lock cams 230a and 230b connected to the shafts 213a and 213b. Specifically, on the basis of the received information on the positions of the shafts 213a and 213b, the controller 300 is able to determine whether the shift lock cams 230a and 230b of the shift lock 200 is, as shown in FIG. 6, in an open-state or, as shown in FIG. 7, in a locked-state.

The sensor 250 may include hall ICs 251a and 251b. The hall ICs 251a and 251b may sense the change of the magnetic force, and thus, detect a distance between the hall IC and the magnets 215a and 215b exposed through ones of both ends of the shafts 213a and 213b respectively.

The hall ICs 251a and 251b may be mounted on a PCB 253. The solenoids 210a and 210b and the PCB 253 of the sensor 250 may be mounted on a mounting plate 290 shown in FIGS. 2 and 3 and fixed.

When the two shift locks 200 are, as shown in FIGS. 1 to 3, provided, the first shift lock 200a and the second shift lock 200b may be operated independently of each other by the controller 300. The description of the detailed operation of the shift lock will be provided in the description of the controller 300.

The sensor 250 independently senses the first shift lock 200a and the second shift lock 200b and transmits the sensed result to the controller 300. In this case, a first hall IC 251a sensing the first shift lock 200a and a second hall IC 251b sensing the second shift lock 200b may be disposed on the PCB 253 of the sensor 250.

The controller 300 controls the shift lock 200 by comparing the speed of the vehicle with a predetermined critical speed of the predetermined gear. Here, the controller 300 may receive information on the speed of the vehicle from the ECU 1000.

The controller 300 compares the speed of the vehicle with the critical speed of the predetermined gear. As a result of the comparison, if the speed of the vehicle is greater than the critical speed, the controller 300 controls the shift lock 200 to be located on the shift path of the predetermined gear, and limits the movement of the rod 110 in the shift direction of the predetermined gear.

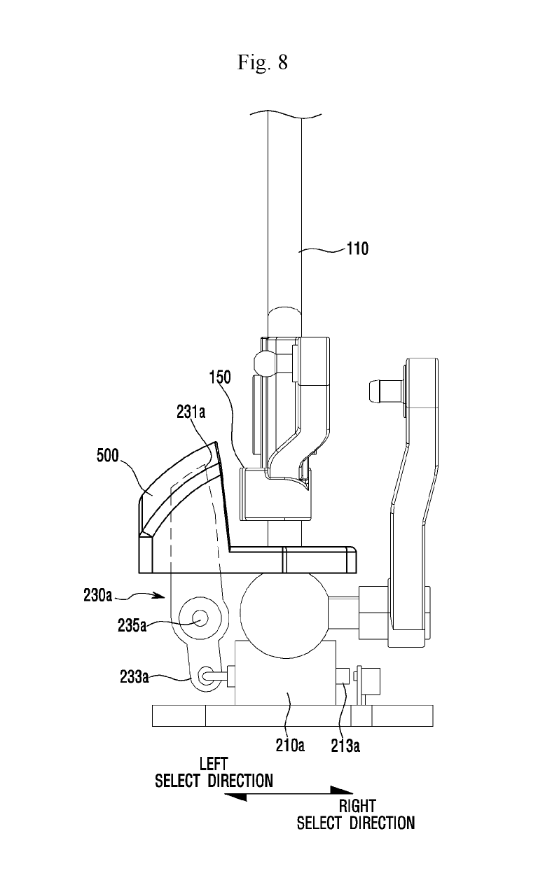

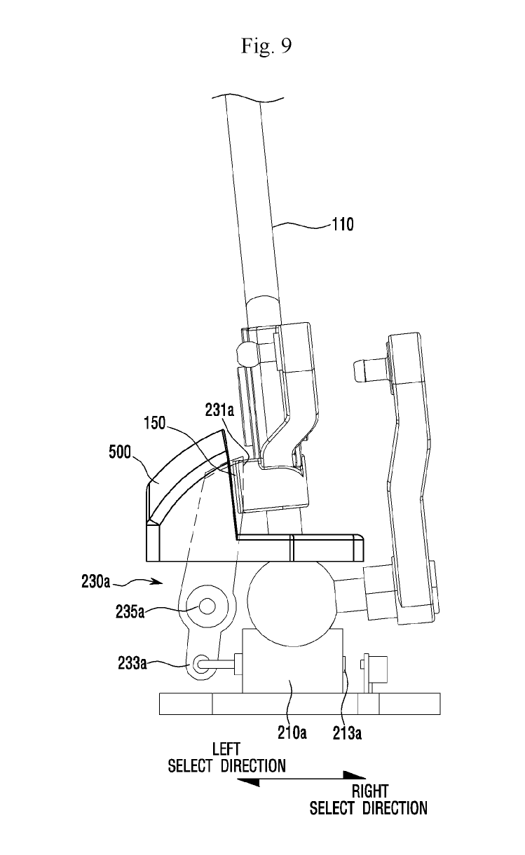

For a concrete example, an example in which the first shift lock 200a shown in FIG. 2 limits the movement of the rod 110 in the shift direction of the first gear will be described with reference to FIGS. 8 to 9.

FIGS. 8 to 9 shows a series of the process preventing shifting to the first gear in a state where the vehicle on which the shift control apparatus of the manual transmission according to the embodiment of the present invention has been mounted travels at a high speed. Specifically, FIG. 8 shows the rod 110 located at the neutral gear position by the driver while the vehicle travels at a high speed. FIG. 9 shows that the driver has moved the rod 110 in the left select direction shown in FIG. 4 along the select path of the first gear in order to change the gear to the first gear.

During the process from FIG. 8 to FIG. 9, the controller 300 shown in FIG. 2 compares the vehicle's speed received from the ECU 1000 with the critical speed of the first gear (hereafter, referred to as a first critical speed). The first critical speed is a predetermined value stored in the controller 300. As a result of the comparison, if the speed of the vehicle is greater than the first critical speed, the controller 300 controls, as shown in FIG. 9, the first shift lock cam 230a of the first shift lock 200a to be located on the shift path of the first gear.

In order that the first shift lock cam 230a is located on the shift path of the first gear, the controller 300 applies a current signal to the first solenoid 210a and causes the first shaft 213a to perform a rectilinear motion in the left select direction. Then, the lower portion 233a of the first shift lock cam 230a rotates clockwise around the first rotational axis 235a at a predetermined angle by the first shaft 213a. Simultaneously with this, the upper portion 231a of the first shift lock cam 230a rotates clockwise at the predetermined angle. When the upper portion 231a of the first shift lock cam 230a is located on the shift path of the first gear by the rotation of the first shift lock cam 230a, the stopper 150 mounted on the rod 110 is blocked by the upper portion 231a of the first shift lock cam 230a, so that the rod 110 cannot proceed any more in the shift direction of the first gear.

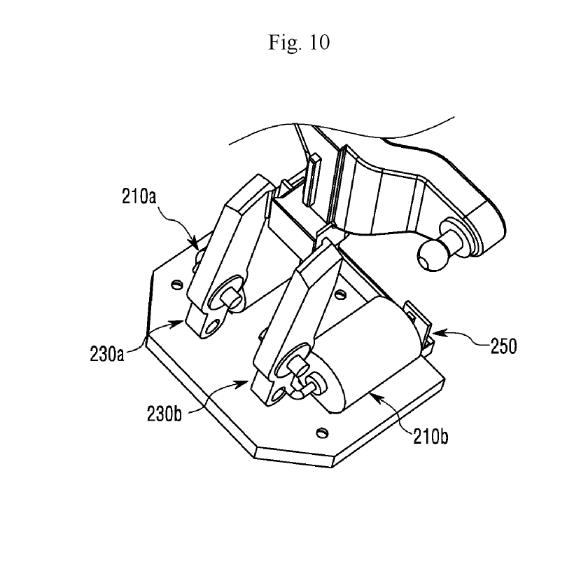

Meanwhile, for another concrete example, an example in which the first shift lock 200a shown in FIG. 2 limits the movement of the rod 110 in the shift direction of the first gear and independently of this, the second shift lock 200b limits the movement of the rod 110 in the shift direction of the second gear will be described with reference to FIG. 10.

FIG. 10 is a view showing a state where the first shift lock 200a and the second shift lock 200b limit the movement of the rod 110.

FIG. 10 shows a result obtained by controlling the first shift lock 200a and the second shift lock 200b shown in FIG. 2 under a predetermined condition by the controller 300 shown in FIG. 2. Hereafter, the predetermined condition will be described in detail.

The controller 300 compares the vehicle's speed received from the ECU 1000 with the critical speed of the first gear and the critical speed of the second gear (hereafter, referred to as a second critical speed). The first and second critical speeds are predetermined values stored in the controller 300.

As a result of the comparison, if the speed of the vehicle is greater than the first critical speed and the second critical speed, the controller 300 controls, as shown in FIG. 10, the first shift lock cam 230a of the first shift lock 200a to be located on the shift path of the first gear and controls the second shift lock cam 230b of the second shift lock 200b to be located on the shift path of the second gear.

Meanwhile, as a result of the comparison, if the speed of the vehicle is greater than the first critical speed and is less than the second critical speed, the controller 300 controls, as shown in FIG. 10, the first shift lock cam 230a of the first shift lock 200a to be located on the shift path of the first gear, and controls the second shift lock cam 230b of the second shift lock 200b not to be located on the shift path of the second gear. This means that while the shifting to the first gear at the current speed of the vehicle is not permitted, the shifting to the second gear is permitted.

Referring back to FIG. 1, the cover 500 is disposed on the bracket 700 and is coupled to the bracket 700.

The cover 500 covers the shift lock 200 shown in FIG. 2 and has an opening that the one end 231a of the first shift lock cam 230a enters. In the open-state shown in FIG. 8, the cover 500 may protect and conceal the first shift lock cam 230a by covering the first shift lock cam 230a. Meanwhile, in the locked-state shown in FIG. 9, the one end 231a of the first shift lock cam 230a may come out through the opening of the cover 500.

The bracket 700 surrounds and protects the shift lever 100, the shift lock 200, and the select lever 900.

The select lever 900 is coupled to the shift lever 100. The select lever 900 is interlocked together with the shift lever 100. When the rod 110 of the shift lever 100 moves in the select direction, the select lever 900 may moves together with the rod 110.

The ECU 1000 senses the speed of the vehicle on which shift control apparatus of the manual transmission according to the embodiment of the present invention is mounted. Also, the ECU 1000 transmits information on the sensed speed of the vehicle to the controller 300. The ECU 1000 may not only sense the speed of the vehicle but also control an electrical system or a subsystem of the vehicle.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A shift control apparatus of a manual transmission, the shift control apparatus comprising:
a shift lever comprising a rod;
a shift lock limiting the movement of the rod; and
a controller which compares a speed of a vehicle with a predetermined critical speed of a predetermined gear and controls the shift lock,
wherein, when the speed of the vehicle is greater than the critical speed, the controller controls the shift lock to be located on a shift path of the predetermined gear, and then limits the movement of the rod in a shift direction of the predetermined gear.

2. The shift control apparatus of a manual transmission of claim 1,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed,
and wherein, when the speed of the vehicle is less than the second critical speed and is greater than the first critical speed, the controller controls the first shift lock to be located on a shift path of the first gear and controls the second shift lock not to be located on a shift path of the second gear.

3. The shift control apparatus of a manual transmission of claim 1,
wherein the shift lock comprises:
a solenoid comprising a shaft which linearly reciprocates in a left select direction of the rod and in a right select direction of the rod; and
a shift lock cam which comprises one end and the other end connected to the shaft, wherein a rotational axis is disposed between the one end and the other end,
and wherein, when the shaft moves in the left select direction by the controller, the one end is located on the shift path of the predetermined gear.

4. The shift control apparatus of a manual transmission of claim 3,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed, and
wherein, when the speed of the vehicle is less than the second critical speed and is greater than the first critical speed, the controller controls the first shift lock to be located on a shift path of the first gear and controls the second shift lock not to be located on a shift path of the second gear.

5. The shift control apparatus of a manual transmission of claim 1,
wherein the shift lock further comprises a shaft which linearly reciprocates in a left select direction of the rod and in a right select direction of the rod, and a sensor which senses a position of the shaft,
wherein the sensor transmits information on the sensed position of the shaft to the controller, and
wherein the controller determines whether the shift lock is in an open-state or in a locked-state on the basis of the received information on the position of the shaft.

6. The shift control apparatus of a manual transmission of claim 5,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed, and
wherein, when the speed of the vehicle is less than the second critical speed and is greater than the first critical speed, the controller controls the first shift lock to be located on a shift path of the first gear and controls the second shift lock not to be located on a shift path of the second gear.

7. The shift control apparatus of a manual transmission of claim 5,
wherein the shaft comprises a magnet, and
wherein the sensor comprises a hall IC which senses a distance between the magnet and the hall IC.

8. The shift control apparatus of a manual transmission of claim 7,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed, and
wherein, when the speed of the vehicle is less than the second critical speed and is greater than the first critical speed, the controller controls the first shift lock to be located on a shift path of the first gear and controls the second shift lock not to be located on a shift path of the second gear.

9. The shift control apparatus of a manual transmission of claim 1,
wherein the shift lever further comprises a stopper mounted on the rod, and
wherein the stopper is mounted to lean in a left select direction of the rod.

10. The shift control apparatus of a manual transmission of claim 9,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed, and
wherein, when the speed of the vehicle is less than the second critical speed and is greater than the first critical speed, the controller controls the first shift lock to be located on a shift path of the first gear and controls the second shift lock not to be located on a shift path of the second gear.

11. The shift control apparatus of a manual transmission of claim 1,
wherein the rod further comprises a stopper, and
wherein the stopper has a shape protruding in a left select direction of the rod.

12. The shift control apparatus of a manual transmission of claim 11,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed, and
wherein, when the speed of the vehicle is less than the second critical speed and is greater than the first critical speed, the controller controls the first shift lock to be located on a shift path of the first gear and controls the second shift lock not to be located on a shift path of the second gear.

13. The shift control apparatus of a manual transmission of claim 1,
further comprising an electronic control unit which measures the speed of the vehicle,
wherein the controller receives the speed of the vehicle from the electronic control unit.

14. The shift control apparatus of a manual transmission of claim 13,
wherein the shift lock comprises a first shift lock and a second shift lock which are operated independently of each other,
wherein the predetermined gear comprises a first gear and a second gear,
wherein the critical speed comprises a first critical speed of the first gear and a second critical speed of the second gear,
wherein the second critical speed is greater than the first critical speed, and
wherein, when the speed of the vehicle is less than the second critical speed and is greater than the first critical speed, the controller controls the first shift lock to be located on a shift path of the first gear and controls the second shift lock not to be located on a shift path of the second gear.
